(19) United States
(12) Patent Application Publication
(10) Pub. No.: US 2025/0087675 A1
(43) Pub. Date: Mar. 13, 2025

(54) METAL OXIDE COATED CORE PARTICLES FOR ANODE ELECTRODES AND METHOD OF MAKING THEREOF

(71) Applicant: NanoGraf Corporation, Chicago, IL (US)

(72) Inventors: Kurt BREITENKAMP, Chicago, IL (US); Nigel BECKNELL, Glen Ellyn, IL (US)

(21) Appl. No.: 18/829,983

(22) Filed: Sep. 10, 2024

Related U.S. Application Data
(60) Provisional application No. 63/582,443, filed on Sep. 13, 2023.

(51) Int. Cl. H01M 4/36; H01M 4/02; H01M 4/04; H01M 4/38; H01M 4/48; H01M 4/62; H01M 10/0525; H01M 10/0562

(52) U.S. Cl. CPC H01M 4/366; H01M 4/0428; H01M 4/386; H01M 4/483; H01M 4/622; H01M 4/625; H01M 10/0525; H01M 10/0562; H01M 2004/021

(57) ABSTRACT

An active material for a lithium ion secondary battery includes core particles containing SiO or M-SiO materials where M is selected from Al, B, Cu, Fe, K, Li, Mg, Na, Ni, Sn, Ti, Zn, Zr, Ca, V, Cr, Nb, Mo, W or any combination thereof, and a metal oxide shell coated on the core particles.

### TECHNICAL FIELD

Aspects of the present disclosure relate to electrode materials including metal oxide coated core particles, and in particular, to anodes including the electrode materials, and lithium ion batteries including the anodes.

### BACKGROUND

Lithium (Li) ion electrochemical cells typically require materials that enable high energy density, high power density and high cycling stability. Li ion cells are commonly used in a variety of applications, which include consumer electronics, wearable computing devices, military mobile equipment, satellite communication, spacecraft devices and electric vehicles, and are particularly popular for use in large-scale energy applications such as low-emission electric vehicles, renewable power plants, and stationary electric grids. Additionally, lithium-ion cells are at the forefront of new generation wireless and portable communication applications. One or more lithium ion cells may be used to configure a battery that serves as the power source for any of these applications. It is the explosion in the number of higher energy demanding applications, however, that is accelerating research for yet even higher energy density, higher power density, higher-rate charge-discharge capability, and longer cycle life lithium ion cells. Additionally, with the increasing adoption of lithium-ion technology, there is an ever increasing need to extend today's energy and power densities, as applications migrate to higher current needs, longer run-times, wider and higher power ranges and smaller form factors.

Active anode materials such as silicon are a desirable replacement for current graphite based anodes due to their high lithium storage capacity that can exceed 7× that of graphite (up to 3200 mAh/g). However, due to the large volume expansion of alloy particles upon lithiation, these anode materials typically exhibit extremely poor cycle life due to mechanical stress, low coulombic efficiency and electrical disconnection.

Accordingly, there is a need for an advanced anode material for use in an electrochemical cell that includes an improved silicon oxide active material.

### SUMMARY

According to an embodiment of the present disclosure, an active material for a lithium ion secondary battery includes core particles containing SiO or M-SiO materials where M is selected from Al, B, Cu, Fe, K, Li, Mg, Na, Ni, Sn, Ti, Zn, Zr, Ca, V, Cr, Nb, Mo, W or any combination thereof, and a metal oxide shell located over the core particles. The metal oxide shell may be formed by atomic layer deposition.

### BRIEF DESCRIPTION OF THE DRAWINGS

FIG. 1A is a sectional diagram of an active material particle 100, according to various embodiments of the present disclosure.

FIG. 1B is a sectional diagram showing a modified active material particle 100A, according to various embodiments of the present disclosure.

FIG. 1C is a sectional diagram showing a composite active material particle, according to various embodiments of the present disclosure.

FIG. 1D is a sectional diagram showing a composite active material particle, according to various embodiments of the present disclosure.

FIG. 1E is a sectional diagram of a core particle, according to various embodiments of the present disclosure.

FIG. 1F is a sectional diagram of a core particle, according to various embodiments of the present disclosure.

FIG. 2A is a sectional diagram of another modified active material particle 100B, according to various embodiments of the present disclosure.

FIG. 2B is a sectional diagram showing yet another modified active material particle 100C, according to various embodiments of the present disclosure.

### DETAILED DESCRIPTION OF THE PREFERRED EMBODIMENTS

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention. It will also be understood that the term “about” may refer to a minor measurement errors of, for example, +/−5% to 10%.

Words such as “thereafter,” “then,” “next,” etc. are not necessarily intended to limit the order of the steps; these words may be used to guide the reader through the description of the methods. Further, any reference to claim elements in the singular, for example, using the articles “a,” “an” or “the” is not to be construed as limiting the element to the singular.

An “electrode material” is defined as a material that may be configured for use as an electrode within an electrochemical cell, such as a lithium ion rechargeable battery. An “electrode” is defined as either an anode or a cathode of an electrochemical cell. A “composite electrode material” is also defined to include active material particles combined with one of particles, flakes, spheres, platelets, sheets, tubes, fibers, or combinations thereof and that are of an electrically conductive material. The particles, flakes, spheres, platelets, sheets, tubes, fibers or combinations thereof may further be one of flat, crumpled, wrinkled, layered, woven, braided, or combinations thereof.

The electrically conductive material may be selected from the group consisting of an electrically conductive carbon-based material, an electrically conductive polymer, graphite, a metallic powder, nickel, aluminum, titanium, stainless steel, and any combination thereof. The electrically conductive carbon-based material may further include one of graphite, graphene, diamond, pyrolytic graphite, carbon black, low defect turbostratic carbon, fullerenes, other carbonaceous materials, or combinations thereof. Herein, other carbonaceous materials may include pyrolyzed carbon materials. Pyrolyzed carbon may be derived from carbonaceous precursor materials, for example: hydrocarbons such as pitch or tar; citric acid; polysaccharides such as sucrose, glucose, or chitosan; polymers such as polyvinyl alcohol (PVA), polyvinylpyrrolidone (PVP), polyacrylic acid (PAA), polydopamine (PDA) or polyacrylonitrile (PAN); combinations thereof; or the like. An “electrode material mixture” is defined as a combination of materials such as: material particles (either electrochemically active, electrically conductive, composite or combinations thereof), a binder or binders, a non-crosslinking and/or a crosslinking polymer or polymers, which are mixed together for use in forming an electrode for an electrochemical cell. An “electrochemically active material”, “electrode active material” or “active material” is defined herein as a material that inserts and releases ions such as ions in an electrolyte, to store and release an electrical potential. The term “inserts and releases” may be further understood as ions that intercalate and deintercalate, or lithiate and delithiate. The process of inserting and releasing of ions is also understood, therefore, to be intercalation and deintercalation, or lithiation and delithiation. An “active material” or an “electrochemically active material” or an “active material particle”, therefore, is defined as a material or particle capable of repeating ion intercalation and deintercalation or lithium lithiation and delithiation.

As defined herein a secondary electrochemical cell is an electrochemical cell or battery that is rechargeable. “Capacity” is defined herein as a measure of charge stored by a battery as determined by the mass of active material contained within the battery, representing the maximum amount of energy, in ampere-hours (Ah), which can be extracted from a battery at a rated voltage. Capacity may also be defined by the equation: capacity=energy/voltage or current (A)×time (h). “Energy” is mathematically defined by the equation: energy=capacity (Ah)×voltage (V). “Specific capacity” is defined herein as the amount of electric charge that can be delivered for a specified amount of time per unit of mass or unit of volume of active electrode material. Specific capacity may be measured in gravimetric units, for example, (Ah)/g or volumetric units, for example, (Ah)/cc. Specific capacity is defined by the mathematical equation: specific capacity (Ah/kg)=capacity (Ah)/mass (kg). “Rate capability” is the ability of an electrochemical cell to receive or deliver an amount of energy within a specified time period. Alternately, “rate capability” is the maximum continuous or pulsed energy a battery can provide per unit of time.

“C-rate” is defined herein as a measure of the rate at which a battery is discharged relative to its maximum nominal capacity. For example, a 1C current rate means that the discharge current will discharge the entire battery in 1 hour; a C/2 current rate will completely discharge the cell in 2 hours and a 2C rate in 0.5 hours. “Power” is defined as the time rate of energy transfer, measured in Watts (W). Power is the product of the voltage (V) across a battery or cell and the current (A) through the battery or cell. “C-Rate” is mathematically defined as C-Rate (inverse hours)=current (A)/capacity (Ah) or C-Rate (inverse hours)=1/discharge time (h). Power is defined by the mathematical equations: power (W)=energy (Wh)/time (h) or power (W)=current (A)×voltage (V). Coulombic efficiency is the efficiency at which charge is transferred within an electrochemical cell. Coulombic efficiency is the ratio of the output of charge by a battery to the input of charge.

Considerable development in both commercial and academic settings has been focused on designing systems that minimize or accommodate total volume swelling of alloy particles and associated electrochemical losses. This has typically been approached on two fronts. At the particle level, designing particle architectures that confine swelling to small domains to prevent particle fracture and electrical disconnection, and at the electrode level, designing a polymer matrix and conductive network that can accommodate the volume swell of the lithium storing materials while retaining mechanical and electronic integrity during repeated charge/discharge operation of the Li-ion cell.

A popular technique to stabilize the cycle life of alloy active anode materials such as silicon is through the mixture, encapsulation or other incorporation by various carbon materials to provide an electronically conducting surface and facilitate general electronic conduction throughout the electrode particle network. This includes CVD amorphous carbon coatings, graphene wrappings, and physical mixing with graphite, conductive carbons, and carbon nanoplatelets. However, active materials may still swell due to their rigid nature and lack of long range order, and particles may still become isolated resulting in storage capacity loss and trapped lithium.

Various embodiments of the present disclosure provide an anode material for Li-ion batteries that includes silicon oxide particles and an amorphous material comprising at least one of boron or phosphorus (“B/P material”) coated on the core particles and diffused into the core particles that increases cycle life stability of the anode material.

### Silicon Oxide Materials

Silicon may significantly increase cell capacity when incorporated within an electrode of an electrochemical cell. Silicon and silicon oxide are often incorporated within an electrode comprising graphite, graphene, or other carbon-based active materials. Examples of electrodes comprising carbon-based materials and silicon are provided in U.S. Pat. Nos. 8,551,650, 8,778,538, and 9,728,773 to Kung et al., and U.S. Pat. Nos. 10,135,059 and 10,135,063 to Huang et al., all the contents of which are fully incorporated herein by reference.

Herein, “SiO materials” may generally refer to silicon and oxygen-containing materials. SiO materials are of interest for use in anode electrodes of lithium-ion batteries, due to having high theoretical energy and power densities. However, the utilization of current commercial SiO materials, such as silicon oxide (e.g., SiOₓ, wherein x ranges from 0.8 to 1.2, such as from 0.9 to 1.1) has been limited due to having a low 1^{st} cycle efficiency and a high irreversibility. This low 1^{st} cycle efficiency is due to high irreversible Li⁺ reaction with the silicon oxide matrix.

In order to decrease the irreversible Li⁺ reaction with SiO materials, various embodiments include metalized (e.g., metal doped) silicon oxide materials (M-SiO). Herein, M-SiO materials refer to active materials that are directly reacted with metal-containing precursors, such as lithium-containing precursors and/or magnesium-containing precursors, to form metalized silicon oxide phases, prior to being utilized in a battery as an active material and/or undergoing charge and discharge reactions. In other words, the metalizing metal remains in the active material and does not intercalate or de-intercalate during battery charging and discharging. In some embodiments, the battery may be a lithium-ion secondary battery, such as a solid-state lithium-ion battery comprising a solid-state anode, a solid-state cathode, and a solid-state electrolyte.

In some embodiments, the embodiment silicon oxide materials may include M-SiO that are metalized to include (i.e., doped with) metals such as Al, B, Ca, Cu, Fe, K, Li, Mg, Na, Ni, Sn, Ti, Zn, Zr, Ca, V, Cr, Nb, Mo, W or any combination thereof. Preferably, the M-SiO materials may comprise lithium-doped (i.e., lithium metalized) SiO (Li—SiO) materials and/or Mg-doped (i.e., Mg metallized) SiO (Mg—SiO) materials.

Electrode materials including M-SiO active materials have been found to provide increased 1^{st} cycle efficiency (FCE), as compared to non-metalized SiO materials. Unfortunately, some M-SiO materials have been found to suffer from particle fracture, severe electrical disconnection, and rapid capacity loss, often leading to more than 90% capacity fade within 20 cycles.

Coating M-SiO materials with carbon and/or other materials, and/or blending M-SiO materials with graphite have been found to slightly reduce the electrical disconnection and capacity loss of active materials, delaying the over 50% capacity fade to ˜50 cycles, which is still highly unsatisfactory cycling stability for commercial applications. Overall, current M-SiO materials do not exhibit electrical stability sufficient for commercialization.

In addition, many conventional M-SiO materials, such as Li-SiOₓ materials, wherein x ranges from 0.8 to 1.2, such as from 0.9 to 1.1, are not chemically stable. Impurities such as Li₂CO₃, LiOH, LiHCO₃, etc., can be found on the surface of Li—SiO anode materials after synthesis. Surface impurities can come from different sources, such as unreacted lithium during the sintering of lithium source precursors with the hydroxide precursors, ion-exchange with moisture, and further reaction with CO₂ during storage. These impurities may cause problems such as gelation of the slurries required for electrode coating, gassing during Li-ion cell storage, shortened cycle-life, etc. In addition, active Si nanoparticles and SiO-type materials are not stable when used in a high-pH environment, which limits some of the electrode or slurry coating procedures available. In particular, a high pH may accelerate the dissolution of silicate species in the glass matrix of SiO materials when it is exposed to the water. Conventional CVD-carbon coating does not prevent this problem.

The high pH of Li—SiO materials may be of particular concern when used in lithium ion cells including cathode materials having a high nickel content. High nickel content positive electrode materials are usually processed in a dry room to minimize the formation of surface impurities during the storage, while a “finishing” process is often used to eliminate surface impurities after synthesis.

Accordingly, there is a need for improved M-SiO materials that provide increased cycle-life, and improved high pH stability. According to various embodiments, silicon oxide active materials include an inorganic surface modification, coating and/or dopant that can stabilize SiO materials.

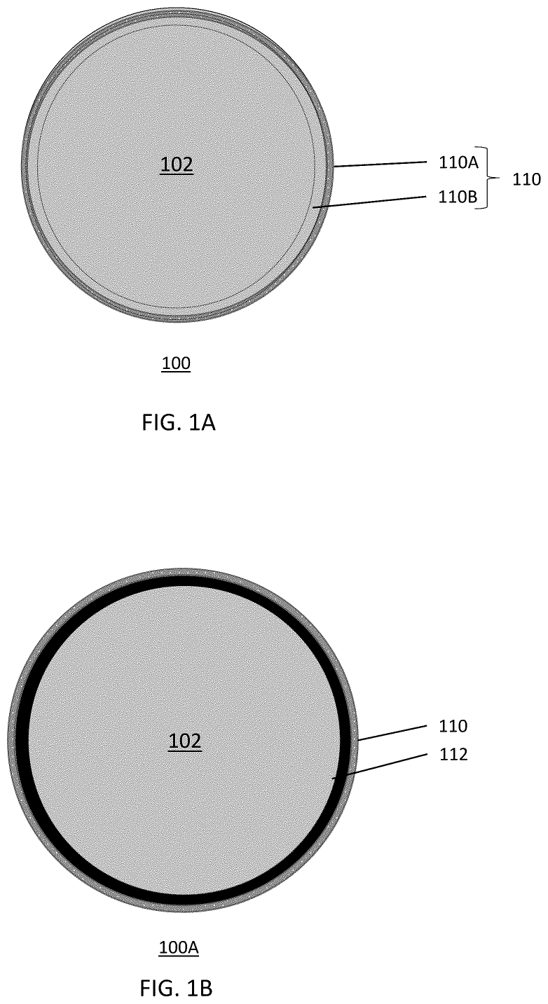

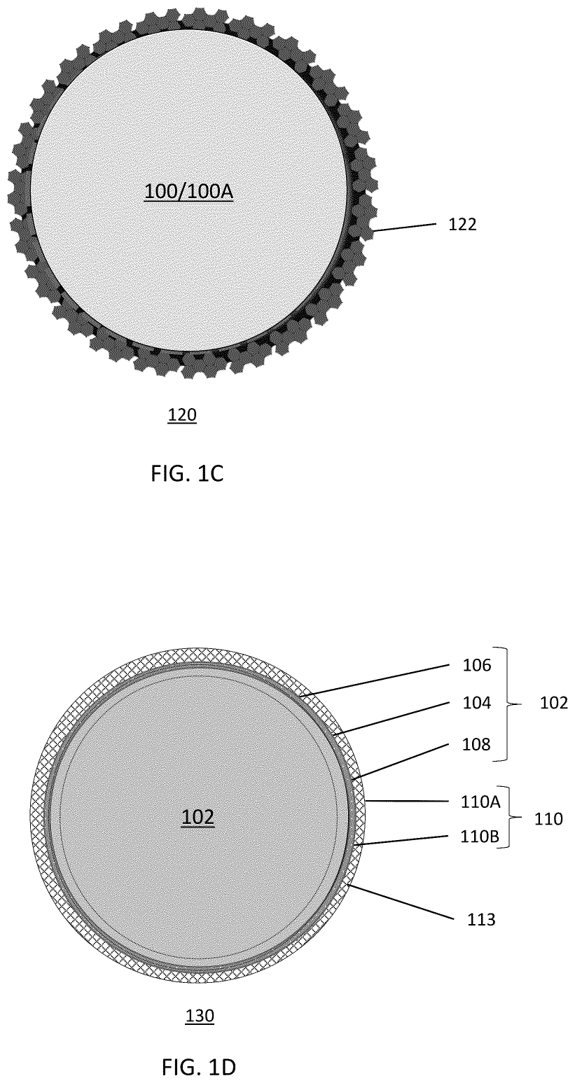

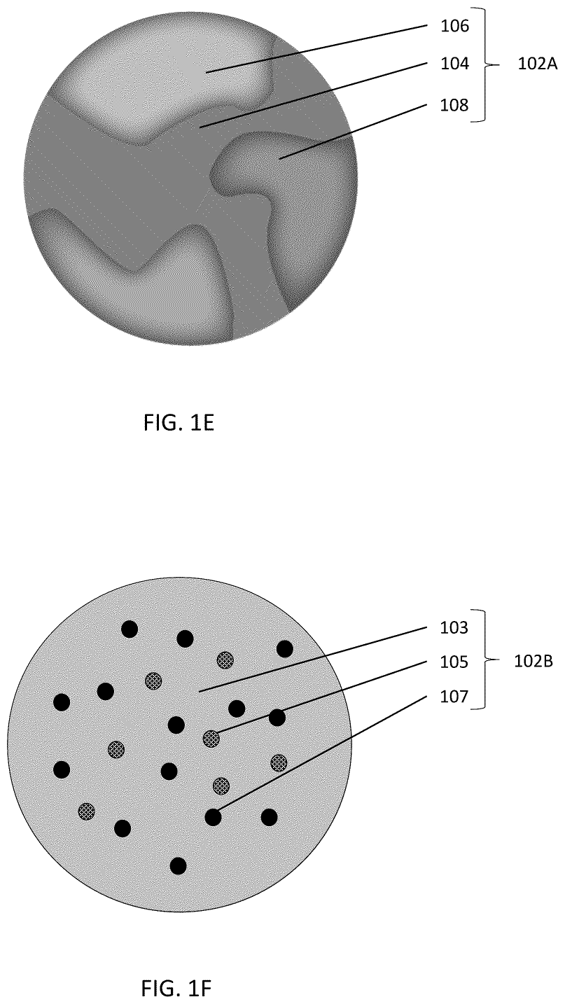

FIG. 1A is a sectional diagram of an active material particle 100, according to various embodiments of the present disclosure. Referring to FIG. 1A, in various embodiments, the active material 100 may include a core particle 102 and a chemical stability structure (CSS) 110 configured to increase the usable cycle life of the core particle 102. The core particle 102 may include M-SiO materials that include metalized silicon species and silicon (e.g., crystalline and/or amorphous silicon). The metalized silicon species may include metalized silicides and metalized silicates. In some embodiments, the M-SiO materials may also include silicon oxide (SiOₓ, wherein x ranges from 0.8 to 1.2, such as from 0.9 to 1.1). In various embodiments, the M-SiO materials may include lithiated silicon species. Herein, “lithiated silicon species” may include lithium silicides (LiₓSi, 0<x<4.4), and/or one or more lithium silicates (Li₂Si₂O₅, Li₂SiO₃, and/or Li₄SiO₄, etc.).

The active material particles 100 may have an average particle size that ranges from about 500 nm to about 20 μm, such as from about 1 μm to about 20 μm, from about 1 μm to about 10 μm, from about 3 μm to about 7 μm, or about 5 μm. The active material particles 100 may have a surface area that ranges from about 0.5 m²/g to about 30 m²/g, such as from about 1 m²/g to about 20 m²/g, including from about 1.5 m²/g to about 15 m²/g.

### Core Particles

FIG. 1E is a sectional diagram of a core particle 102A, according to various embodiments of the present disclosure. Referring to FIG. 1E, the core particle 102A may include heterogeneous silicon-containing phases 104, 106, 108. For example, the silicon-containing phases 104, 106, 108 may independently comprise crystalline and/or amorphous silicon, silicon oxide (e.g., SiOₓ, wherein x ranges from 0.8 to 1.2, such as from 0.9 to 1.1), and/or lithiated silicon species. However, in some embodiments the core particle 102A material may be substantially homogeneous and may lack distinct phases, but includes silicon, oxygen and optionally Li and/or Mg.

FIG. 1F is a sectional diagram of an active material core particle 102B, according to various embodiments of the present disclosure. Referring to FIG. 1F, the core particle 102B may include a primary phase 103, in which crystalline silicon domains 105 are dispersed as a secondary phase. For example, the primary phase 103 may include lithiated silicon species such as lithium silicate species, and in particular, Li₂SiO₃, Li₄SiO₄, and Li₂Si₂O₅. In other embodiments, the primary phase 103 may comprise magnesium-metalized silicon species, magnesium silicate species, and in particular MgSiO₃, Mg₂SiO₄, or combination thereof. The crystalline silicon domains 105 may comprise crystalline silicon nanoparticles having a particle size of less than 100 nm. For example, the crystalline silicon domains 105 may have an average particle size ranging from about 3 nm to about 60 nm. In one embodiment, a majority of the crystalline silicon domains 105 may have an average particle size ranging from about 5 nm to about 10 nm, and a remainder of the crystalline silicon domains 105 may have an average particle size from about 10 nm to about 50 nm.

In some embodiments, the core particle 102B may optionally include SiOₓ domains 107 (e.g., SiOₓ, wherein x ranges from 0.8 to 1.2, such as from 0.9 to 1.1) dispersed in the primary phase 103 as secondary phases. The SiOₓ domains 107 may have a particle size of less than about 100 nm. For example, the SiOₓ domains 107 may have an average particle size ranging from about 3 nm to about 60 nm, such as from about 5 nm to about 50 nm.

Referring to FIGS. 1A-F, the core particles 102A, 102B may utilized as the core particles 102 discussed above. In various embodiments, the core particles 102 may represent from about 80 wt % to about 99.5 wt %, such as from about 90 wt % to about 99 wt %, including about 90 wt % to 95 wt % of the total weight of the composite particles 100. In some embodiments the M-SiO material may include from about 40 at % to about 5 at %, such as from 20 at % to about 10 at %, or about 15 at % of lithiated silicon species. In some embodiments the M-SiO material of the core particles 102A may include from about 60 at % to about 95 at %, such as from about 80 at % to about 90 at %, or about 85 at % silicon and SiOₓ. The M-SiO material of the core particles 102 may have a silicon to oxygen atomic weight ratio ranging from about 1.25:1 to about 1:1.25, such as from about 1.1:1 to about 1:1.1, or of about 1:1. In some embodiments, the M-SiO material of the core particles 102 may comprise approximately equal atomic amounts of crystalline silicon and SiOₓ.

During an initial charging reaction and/or subsequent charging reactions, the composition of the M-SiO material of the core particles 102A may change due to lithiation and/or other reactions. For example, Si and SiOₓ may be lithiated to form LiₓSi domains. In addition, some SiOₓ may form inactive species, such as lithium silicates and Li₂O.

Amorphous carbon is often used as an additive or surface coating for both electrochemical cell anode and cathode material mixtures to enhance electrode conductivity. Typically, amorphous carbons are produced using a chemical vapor deposition (CVD) process wherein a hydrocarbon feedstock gas is flowed into a sealed vessel and carbonized at elevated temperatures onto the surface of a desired powder material. This thermal decomposition process can provide thin amorphous carbon coatings, on the order of a few nanometers thick, which lack any sp2 hybridization as found in crystalline graphene-based materials.

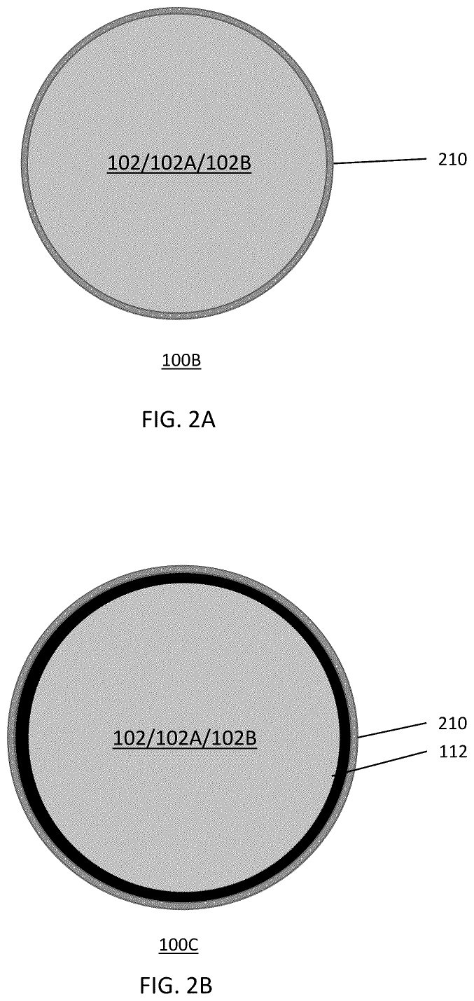

FIG. 2A illustrates active material particles 100B according to an alternative embodiment of the present disclosure. The active material particles may comprise any of the core particles 102, 102A or 102B described above. For example, the core particles may comprise a SiO material or an M-SiOₓ material, wherein 0<x<1.2, and M is selected from Al, B, Ca, Cu, Fe, K, Li, Mg, Na, Ni, Sn, Ti, Zn, Zr, Ca, V, Cr, Nb, Mo, W or any combination thereof. In one embodiment, the core particles may comprise Li and/or Mg doped silicon oxide particles, which may optionally be also doped with boron and/or aluminum. Thus, the core particles may comprise the M-SiO materials, which include lithium-doped (i.e., lithium metalized) SiO (Li—SiO) materials and/or Mg-doped (i.e., Mg metallized) SiO (Mg—SiO) materials, which may also be optionally doped with boron and/or aluminum. The core particles may have the structure and/or phases of the core particles 102A or 102B described above.

The active material particles 100B are coated with a metal oxide shell 210 instead of the chemical stability structure (CSS) 110 described above with respect to the previous embodiments. In the embodiment shown in FIG. 2A the metal oxide shell 210 is deposited directly on the core particles 102, 102A or 102B using any suitable deposition method. In one embodiment, the metal oxide shell 210 is deposited using a vapor phase deposition method, such as atomic layer deposition (ALD). The metal oxide shell may comprise any suitable metal oxide material, such as aluminum oxide (e.g., alumina), titanium oxide (e.g., titania) and/or zinc oxide (e.g., ZnO). The metal oxide shell 210 may have any suitable thickness, such as 1 to 100 nm, for example, 1 to 5 nm. If the metal oxide shell 210 is relatively thin (e.g., 1-3 nm thick), then it may be a continuous shell which completely encloses the core particles, or a discontinuous shell which has gaps in it and partially encloses the core particles. In one embodiment, the metal oxide shell 210 covers at least 60% of the surface of the core particles.

FIG. 2B illustrates active material particles 100C according to another alternative embodiment of the present disclosure. The active material particles 100C include the above described carbon layer 112 located between the core particles 102, 102A or 102B and the metal oxide shell 210. Thus, the carbon layer 112 may be deposited directly on the core particles and the metal oxide shell 210 may be deposited directly on the carbon layer 112.

In the above embodiments, based on the total weight of the active material (e.g., 100B, 100C or 220) for a lithium ion secondary battery, the active material comprises: from about 90 wt % to about 99 wt % of the core particles 102, 102A or 102B; from about 0.01 wt % to about 10 wt % of the metal oxide shell 210; and from 0 to about 5 wt % of a carbon material 112 disposed between the metal oxide shell and the core particles. Preferably, the active material comprises from about 0.01 wt % to about 5 wt % of the metal oxide shell; and from about 95 wt % to about 99.99 wt % of the core particles.

### Electrode Materials

Various embodiments of the present disclosure provide electrode materials for Li-ion batteries, and in particular, anode electrode compositions. The electrode material may include an active material as described above, a binder, and optionally single-wall carbon nanotubes (SWCNTs). The active material may include the above described active material particles 100 or 100A, or the encapsulated particles 120 (i.e., containing the active material particles 100 or 100A encapsulated in the shell 122) and optionally additional graphite particles. In some embodiments, the electrode materials may optionally include a conductive additive, such as carbon black. The active material and the graphite particles may be mixed with each other. The carbon black particles may be smaller (i.e., have a smaller diameter) than the silicon oxide particles and the graphite particles, and may be located between and/or on surfaces of the silicon oxide particles and/or the graphite particles. The SWCNTs may extend between the mixture of silicon oxide particles and the graphite particles and provide long range conductivity across multiple active particles.

The electrode materials may include an active material comprising SiO or M-SiO material core particles or a SiO or M-SiO material core particle with a metal oxide shell, as described above. Thus, the core particles may include silicon, metal silicate, and silicon oxide phases and optional lithiated silicon species, and a coating and/or diffusion layer including boron and/or phosphorus, described above. The active material particles may include the optional carbon coating, or the carbon coating may be omitted.

The active material may have an average particle size that ranges from about 1 μm to about 20 μm, such as from about 1 μm to about 15 μm, from about 3 μm to about 10 μm, or from about 5 μm to about 8 μm. The active material particles may have a surface area that ranges from about 0.5 m²/g to about 30 m²/g, such as from about 1 m²/g to about 20 m²/g, including from about 1.5 m²/g to about 15 m²/g.

The electrode materials may include at least 20 wt % of the active material, such as from about 30 wt % to about 98 wt %, including from about 70 wt % to about 90 wt %, or about 75 wt % of the active material.

The electrode material may optionally include graphite particles. For example, the electrode material may include from about 0 wt % to about 97 wt %, such as from about 50 wt % to about 95 wt %, from about 5 wt % to about 35 wt %, from about 10 wt % to about 30 wt %, or from about 15 wt % to about 25 wt % graphite particles, and from about 3 wt % to about 100 wt %, such as from about 5 wt % to about 50 wt %, from about 95 wt % to about 65 wt %, 90 wt % to about 70 wt %, or from about 85 wt % to about 75 wt % of the active material particles. It should be noted that graphite may also act as an active material during battery operation. However, the active material particles are described herein separately from the graphite particles for clarity of description.

The graphite may include graphite particles of synthetic or natural origin. The graphite may have an average particle size ranging from about 2 μm to about 30 μm, such as from about 10 μm to about 20 μm, including from about 12 μm to about 18 μm. In one embodiment, the average particle size of the graphite particles may be larger than the average particle size of the silicon oxide active material particles 100. The graphite particles may have a surface area that ranges from about 0.5 m²/g to about 2.5 m²/g, such as from about 1 m²/g to about 2 m²/g. The graphite particles 130 may be larger than the silicon oxide particles.

The electrode material may include any suitable electrode material binder. For example, the electrode material may include a polymer binder such as polyvinylidene difluoride (PVDF), Na-carboxymethyl cellulose (CMC), styrene butadiene rubber (SBR), polyacrylic acid (PAA), lithium polyacrylate (LiPAA), a combination thereof, or the like. In some embodiments, the binder may include a combination of the CMC and the SBR, where the CMC has a molecular weight from 250 to 850 g/mol and a degree of substitution from 0.65 to 0.9.

In various embodiments, the electrode material may include from about 1 wt % to about 12 wt %, such as from about 2 wt % to about 10 wt %, or from about 2 to about 8 wt % of the binder. In some embodiments, the electrode material may include from about 95 wt % to about 98 wt % of the active material, from about 1 wt % to about 2 wt % conductive agent, and from about 2 wt % to about 4 wt % binder, which may include CMC and SBR.

In some embodiments, the SWCNTs may have an average length of greater than about 1 μm. For example, the SWCNTs may have an average length ranging from about 1 μm to about 500 μm, such as from about 1 μm to about 10 μm. The SWCNTs may have an average diameter ranging from about 0.5 nm to about 2.5 nm, such as from about 1 nm to about 2 nm.

The SWCNTs may have an IG/I_{D} ratio or greater than about 5, such as greater than about 6 or greater than about 10, as determined by Raman spectroscopy, with IG being associated with the Raman intensity at wavenumber 1580-1600 cm⁻¹, and I_{D} being associated with the Raman intensity at wavenumber 1330-1360 cm⁻¹, as measured using an incident laser wavelength of 633 nm.

In various embodiments, the electrode material may include from about 0 to about 1 wt %, such as from about 0.075 wt % to about 0.9 wt %, from about 0.08 wt % to about 0.25 wt %, or about 0.1 wt % SWCTNs.

The conductive additive may include carbon black (e.g., KETJENBLACK or Super-P carbon black), low defect turbostratic carbon, acetylene black, channel black, furnace black, lamp black, thermal black, or combinations thereof. The conductive additive may optionally include metal powder, fluorocarbon powder, aluminum powder, nickel powder; nickel flakes, conductive whiskers, zinc oxide whiskers, potassium titanate whiskers, conductive metal oxides, titanium oxide, conductive organic compounds, conductive polyphenylene derivatives, conductive polymers, or combinations thereof.

In various embodiments, the electrode material may include from 0 to about 10 wt %, such as from about 0.25 wt % to about 7 wt %, from about 2 wt % to about 7 wt %, or about 5 wt % conductive additive. In some embodiments, the conductive additive may preferably include carbon black.

### Anode Formation

According to various embodiments, an anode may be formed using any suitable method known to one or skill in the art. For example, active material particles (e.g., SiO material and/or M-SiO material particles having a CSS described above) may be mixed with graphite particles to form an active material. In one embodiment, the active material may include less than 50 wt % silicon oxide and more than 50 wt % graphite. The active material may be mixed with the binder and the optional SWCNTs and/or conductive additives to form a solids component. In some embodiments, the silicon oxide particles may be encapsulated in a turbostratic carbon shell 122 using, for example, a spray drying process, prior to forming the active material. Alternatively, the shell 122 may be omitted.

The solids component may be mixed with a polar solvent such as water or N-Methyl-2-pyrrolidone (NMP), at a solids loading between about 20-60 wt %, to form an electrode slurry. For example, the mixing may include using a planetary mixer and high shear dispersion blade, under vacuum.

The electrode slurry may then be coated onto a metal substrate, such as a copper or stainless steel substrate, at an appropriate mass loading to balance the lithium capacity of the anode with that of a selected cathode. Coating can be conducted using a variety of apparatus such as doctor blades, comma coaters, gravure coaters, and slot die coaters.

After coating, the slurry may be dried to form an anode. For example, the slurry may be dried under forced air, at a temperature ranging from room temperature to about 120° C. The dried slurry may be pressed to reduce the internal porosity, and the electrode may be cut to a desired geometry. Typical anode pressed densities can range from about 1.0 g/cc to about 1.7 g/cc depending on the composition of the electrode and the target application. Cathode pressed densities may range from about 2.7 to about 4.7 g/cc.

### Electrochemical Cell Assembly

Construction of an electrochemical cell involves the pairing of a coated anode substrate and a coated cathode substrate that are electronically isolated from each other by a polymer and/or a ceramic electrically insulating separator. The electrode assembly is hermetically sealed in a housing, which may be of various structures, such as but not limited to a coin cell, a pouch cell, or a can cell, and contains a nonaqueous, ionically conductive electrolyte operatively associated with the anode and the cathode. The electrolyte is comprised of an inorganic salt dissolved in a nonaqueous solvent and more preferably an alkali metal salt dissolved in a mixture of low viscosity solvents including organic esters, ethers and dialkyl carbonates and high conductivity solvents including cyclic carbonates, cyclic esters and cyclic amides. A non-limiting example of an electrolyte may include a lithium hexafluorophosphate (LiPF₆) or lithium bis(fluorosulfonyl)imide (LiFSi) salt in an organic solvent comprising one of: ethylene carbonate (EC), diethyl carbonate (DEC), dimethyl carbonate (DMC), fluoroethylene carbonate (FEC) or combinations thereof.

Additional solvents useful with the embodiment of the present invention include dialkyl carbonates such as tetrahydrofuran (THF), methyl acetate (MA), diglyme, trigylme, tetragylme, 1,2-dimethoxyethane (DME), 1,2-diethoxyethane (DEE), 1-ethoxy, 2-methoxyethane (EME), ethyl methyl carbonate, methyl propyl carbonate, ethyl propyl carbonate, dipropyl carbonate, and combinations thereof. High permittivity solvents that may also be useful include cyclic carbonates, cyclic esters and cyclic amides such as propylene carbonate (PC), butylene carbonate, acetonitrile, dimethyl sulfoxide, dimethyl formamide, dimethyl acetamide, gamma-valerolactone, gamma-butyrolactone (GBL), N-methyl-2-pyrrolidone (NMP), and combinations thereof.

The electrolyte may also include one or more additives, such as vinylene carbonate (VC), 1,3-propane sulfone (PS), prop-1-ene-1,3-sultone (PES), Flouroethylene carbonate (FEC), and/or propylene carbonate (PC). The electrolyte serves as a medium for migration of lithium ions between the anode and the cathode during electrochemical reactions of the cell, particularly during discharge and re-charge of the cell. The electrochemical cell may also have positive and negative terminal and/or contact structures.

In some embodiments, the electrolyte may be a solid-state electrolyte including a Li—B silicate and/or Li-silicate.

Although the foregoing refers to particular preferred embodiments, it will be understood that the invention is not so limited. It will occur to those of ordinary skill in the art that various modifications may be made to the disclosed embodiments and that such modifications are intended to be within the scope of the invention. All of the publications, patent applications and patents cited herein are incorporated herein by reference in their entirety.

What is claimed is:

1. An active material for a lithium ion secondary battery, comprising:
core particles comprising a SiO material or a M-SiOₓ material, wherein 0<x<1.2, and M is selected from Al, B, Ca, Cu, Fe, K, Li, Mg, Na, Ni, Sn, Ti, Zn, Zr, Ca, V, Cr, Nb, Mo, W or any combination thereof; and
a metal oxide shell located over the core particles.

2. The active material of claim 1, further comprising a carbon layer disposed between the metal oxide shell and the core particles, the carbon layer comprising pyrolyzed carbon, activated carbon, or carbon black.

3. The active material of claim 1, wherein the metal oxide shell covers at least 60% of the surface of the core particles.

4. The active material of claim 1, wherein, based on the total weight of the active material, the active material comprises:
from about 90 wt % to about 99 wt % of the core particles;
from about 0.01 wt % to about 10 wt % of the metal oxide shell; and
from 0 to about 5 wt % of a carbon material disposed between the metal oxide shell and the core particles.

5. The active material of claim 4, wherein, based on the total weight of the active material, the active material comprises:
from about 0.01 wt % to about 5 wt % of the metal oxide shell; and
from about 95 wt % to about 99.99 wt % of the core particles.

6. The active material of claim 1, wherein:
the core particles have an average particle size ranging from about 500 nanometers to about 20 microns;
the metal oxide shell has a thickness ranging from 1 nm to about 100 nm.

7. The active material of claim 6, wherein the metal oxide shell has a thickness ranging from 1 nm to about 5 nm.

8. The active material of claim 1, wherein the metal oxide shell comprises aluminum oxide, titanium oxide, zinc oxide or a combination thereof.

9. The active material of claim 1, wherein the metal oxide shell is formed by atomic layer deposition.

10. The active material of claim 1, wherein:
the core particles comprise M-SiO;
M comprises Li; and
the M-SiO comprises at least one of crystalline or amorphous silicon domains, lithiated silicon species domains, and silicon oxide domains comprising SiO_{y}, where y ranges from 0.8 to 1.2.

11. The active material of claim 10, wherein:
the metal oxide shell comprises aluminum oxide, titanium oxide, zinc oxide, or a combination thereof; and
the M-SiO comprises lithiated silicon species domains comprising Li₂Si₂O₅, Li₂SiO₃, Li₄SiO₄, or a combination thereof.

12. The active material of claim 10, wherein:
the metal oxide shell comprises aluminum oxide, titanium oxide, zinc oxide, or a combination thereof; and
the M-SiO comprises magnesium silicate species domains comprising MgSiO₃, Mg₂SiO₄, or a combination thereof.

13. The active material of claim 12, wherein the M-SiO further comprises lithiated silicon species domains comprising Li₂Si₂O₅, Li₂SiO₃, Li₄SiO₄, or a combination thereof in addition to the magnesium silicate species.

14. The active material of claim 1, wherein the core particles comprise at least one of crystalline or amorphous silicon domains, and silicon oxide domains comprising SiO_{y}, where y ranges from 0.8 to 1.2.

15. A lithium ion secondary battery, comprising:
an anode comprising an electrode material comprising the active material of claim 1 and a binder;
a separator;
a cathode; and
an electrolyte disposed between the anode and cathode.

16. The lithium ion secondary battery of claim 15, wherein the electrode material comprises, based on total weight of the active material:
from about 0.3 wt % to about 30 wt % of a binder;
from about 0.01 wt % to about 20 wt % of a conductive additive;
from about 0 wt % to about 97 wt % graphite particles; and
from about 3 wt % to about 100 wt % of the active material.

17. The lithium ion secondary battery of claim 15, wherein the active material comprises:
from about 50 wt % to about 95 wt % of the graphite particles; and
from about 5 wt % to about 50 wt % of the active material particles.

18. The lithium ion secondary battery of claim 15, wherein the binder comprises polyvinylidene difluoride (PVDF), Na-carboxymethyl cellulose (CMC), styrene butadiene rubber (SBR), polyacrylic acid (PAA), lithium polyacrylate (LiPAA), polyimide (PI), or a combination thereof.

19. The lithium ion secondary battery of claim 15, wherein the lithium ion battery is a solid state lithium battery comprising a solid-state anode, a solid state cathode, and a solid-state electrolyte.

20. A method of forming an active material for a lithium ion secondary battery, comprising:
providing core particles comprising a SiO material or a M-SiOₓ material, wherein 0<x<1.2, and M is selected from Al, B, Ca, Cu, Fe, K, Li, Mg, Na, Ni, Sn, Ti, Zn, Zr, Ca, V, Cr, Nb, Mo, W or any combination thereof; and
forming a metal oxide shell over the core particles by atomic layer deposition.
